(19) United States
(12) Patent Application Publication
(10) Pub. No.: US 2017/0075825 A1
(43) Pub. Date: Mar. 16, 2017

(54) AUTOMATIC MEMORY SECURITY

(71) Applicant: FREESCALE SEMICONDUCTOR, INC., Austin, TX (US)

(72) Inventors: Guoyin Chen, Shanghai (CN); Haoran Wang, Suzhou (CN); Zening Wang, Nanjing (CN)

(21) Appl. No.: 15/235,069

(22) Filed: Aug. 11, 2016

(30) Foreign Application Priority Data
Sep. 14, 2015 (CN) 201510723962.4

(51) Int. Cl. G06F 12/14; H04L 9/08; H04L 29/06

(52) U.S. Cl. CPC G06F 12/1433; H04L 63/061; H04L 9/0869; G06F 2212/1052

(57) ABSTRACT

A computing device has a security module that (i) receives a request to decrypt encrypted data; (ii) sets up an uninterruptible timer based on a specified time interval; (iii) decrypts the encrypted data to generate and stores corresponding decrypted data in a memory within the computing device; and (iv) provides a trigger signal to delete the decrypted data from the memory after expiration of the specified time interval as determined by the timer. The security module limits the duration that the decrypted data is stored in the memory and thus reduces the chance the data can be subject to unauthorized accessed.

### BACKGROUND

The present invention relates to computing devices and, more particularly, to the protection of sensitive information stored in the memory of a computing device.

Security is a critical feature in various computing devices. It is important to be able to store sensitive information in a computing device and protect that information from unauthorized disclosure and/or modification. Whenever sensitive information is stored in memory, there is a risk that it might be improperly accessed.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a schematic block diagram of a security module that performs encryption processing according to an embodiment of the present invention;

FIG. 2 is a schematic block diagram of the security module of FIG. 1 performing decryption processing according to an embodiment of the invention;

FIG. 3 is a schematic block diagram of the security module of FIG. 1 performing decryption processing according to another embodiment of the invention; and

FIG. 4 is a schematic block diagram of a device including the security module of FIG. 1 in accordance with an embodiment of the present invention.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In one embodiment, a computing device includes a security module configured to (i) receive a request to decrypt encrypted data; (ii) set up an uninterruptible timer based on a specified time interval; (iii) decrypt the encrypted data to generate and store corresponding decrypted data in a memory within the computing device; and provide a trigger signal to delete the decrypted data from the memory after expiration of a specified time interval as determined by the timer.

It is risky to store sensitive data in the memory of a computing device because the data may be improperly accessed from the memory by an unauthorized user, such as a hacker. According to embodiments described herein, the period of time that the sensitive data is stored is limited using an uninterruptible timer.

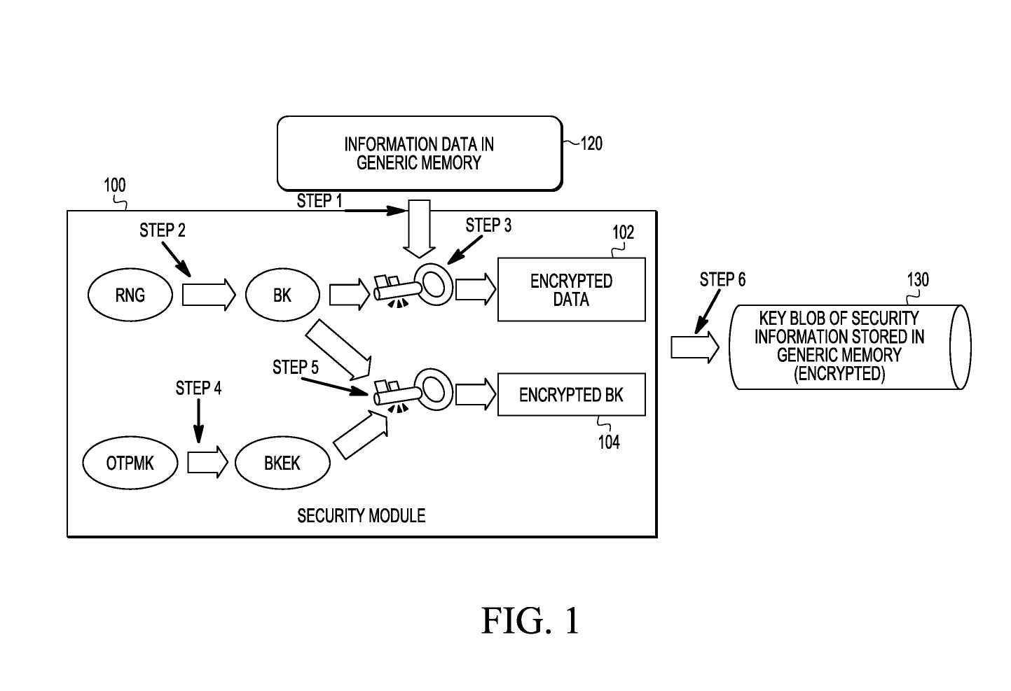

Referring now to FIG. 1, a block diagram of a security module 100 that performs encryption processing according to an embodiment of the invention is shown. The security module 100 encrypts sensitive data 120 stored in generic system memory and generates a corresponding encrypted key blob 130 that is stored back into the generic system memory.

In particular, in step 1, the security module 100 receives a request (e.g., from a user) to encrypt the data 120 stored in the generic system memory. In step 2, the security module 100 requests and receives a randomly generated blob key BK generated by a hardware random number generator RNG implemented within the security module 100. In step 3, the security module 100 encrypts the data 120 using the blob key BK to generate encrypted data 102.

In step 4, the security module 100 retrieves a blob-key encryption key BKEK from a one-time programmable master key (OTPMK) register, which is also implemented within the security module 100. In step 5, the security module 100 encrypts the blob key BK using the blob-key encryption key BKEK to generate an encrypted blob key 104. In step 6, the security module 100 combines the encrypted data 102 generated in step 3 and the encrypted blob key 104 generated in step 5 to generate the key blob 130 that is saved in the generic system memory.

Note that security module 100 may be used to encrypt and store multiple, different sets of data 120 as different key blobs 130 in the generic system memory, with each key blob 130 being encrypted using a unique, randomly generated blob key BK and the same blob-key encryption key BKEK.

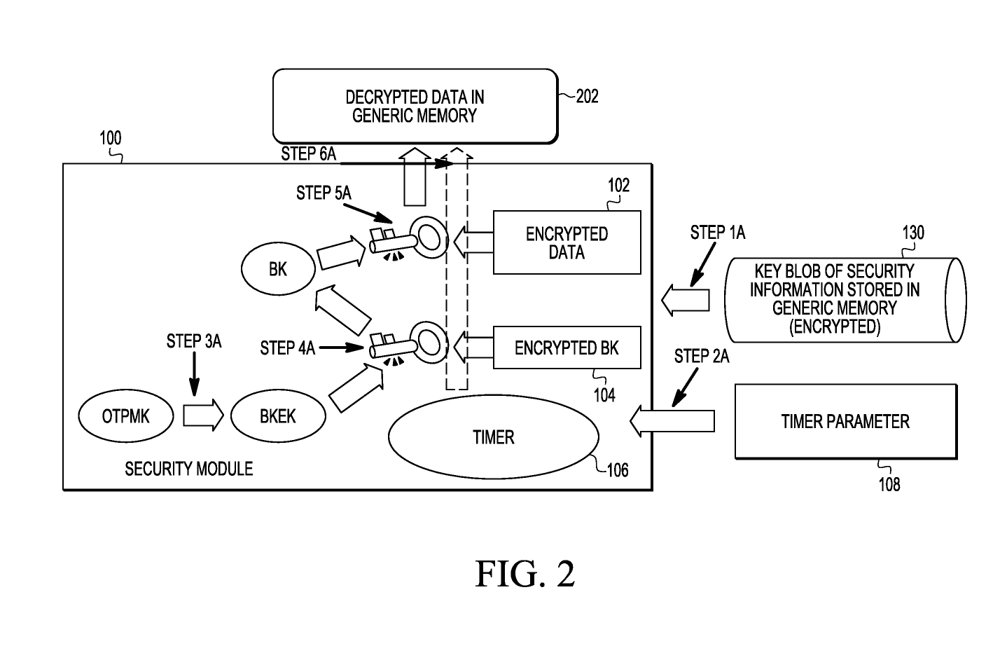

FIG. 2 is a block diagram of the security module 100 of FIG. 1 performing decryption processing according to an embodiment of the invention. In FIG. 2, the security module 100 decrypts the key blob 130 stored in the generic system memory and stores the corresponding decrypted data 202 back in the generic system memory. In accordance with the present invention, the decrypted data 202 is automatically deleted after the expiration of an uninterruptible timer 106.

In particular, in step 1a of FIG. 2, the security module 100 receives a request (e.g., from a user) to decrypt the encrypted key blob 130 stored in the generic system memory. In step 2a, the security module 100 sets up the uninterruptible timer 106 using a specified time interval parameter 108. The parameter 108 can be provided by the user as a programmable value or by the system as a fixed, default value, depending on the implementation. It is noted that the timer 106 may be a count-up timer that counts from zero up to the specified time interval or a count-down timer that counts from the specified time interval down to zero. Also, the timer 106 may be configured to start counting right after receiving the request or, at some later time, such as after the encrypted data has been decrypted.

As in Step 4 of FIG. 1, in Step 3a, the security module 100 retrieves the same blob-key encryption key BKEK from the one-time programmable register OTPMK. In Step 4a, the security module 100 retrieves the encrypted blob key 104 from the key blob 130 and decrypts the encrypted blob key 104 using the blob-key encryption key BKEK to generate a decrypted version of the blob key BK.

In step 5a, the security module 100 retrieves the encrypted data 102 from the key blob 130 and decrypts the encrypted data 102 using the decrypted key blob BK from Step 4a, generating and storing the corresponding decrypted data 202 into the generic system memory.

Finally, in step 6a, after expiration of the specified time interval, the timer 106 provides a trigger signal to delete (e.g., zeroize) the decrypted data 202 from the generic system memory. As an uninterruptible timer, once the timer 106 starts counting, it cannot be interrupted. In this way, the decrypted data 202 is available in the generic system memory for only a limited period of time, thereby reducing the risk of unauthorized access to the data compared with systems that do not have the uninterruptible timer 106.

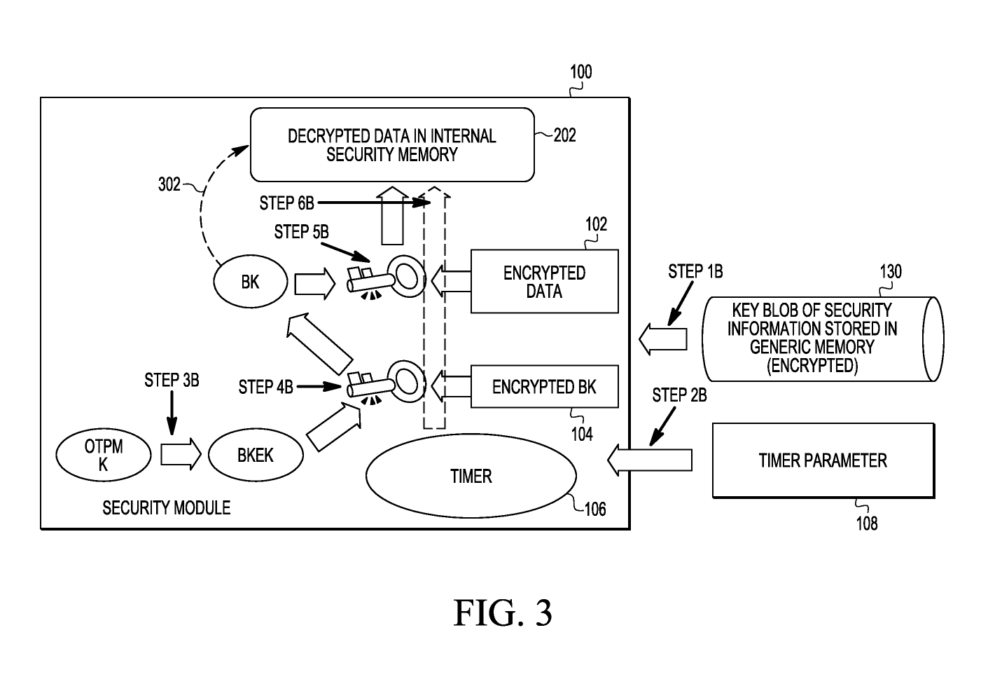

FIG. 3 is a block diagram of the security module 100 of FIG. 1 performing decryption processing according to another embodiment of the invention. As in the decryption processing of FIG. 2, the security module 100 decrypts the key blob 130 stored in the generic system memory and stores the corresponding decrypted data 202 in memory. In accordance with the present invention, the stored data is automatically deleted from the memory after the expiration of a predetermined time period as indicated by the uninterruptible timer 106.

The main difference between the decryption processing of FIG. 2 and the decryption processing of FIG. 3 is that, in FIG. 3, the decrypted data 202 is stored in a memory that is internal to the security module 100 instead of being stored in a generic system memory that is external to the security module. As indicated by arrow 302 in FIG. 3, the decrypted blob key BK is also stored in the security module's internal memory.

thus, steps 1b-4b of FIG. 3 are identical to steps 1a-4a of FIG. 2. Step 5b of FIG. 3 is identical to step 5a of FIG. 2, except that the decrypted data 202 is stored in the security module's internal memory. Step 6b of FIG. 3 is identical to step 6a of FIG. 2, except that the decrypted data 202 is automatically deleted from the security module's internal memory after expiration of the specified time interval. Here, too, even though the security module's internal memory is probably more secure than a generic system memory, in the decryption processing of FIG. 3, the risk of unauthorized access to the decrypted data 202 is still reduced compared with systems that do not have the uninterruptible timer 106.

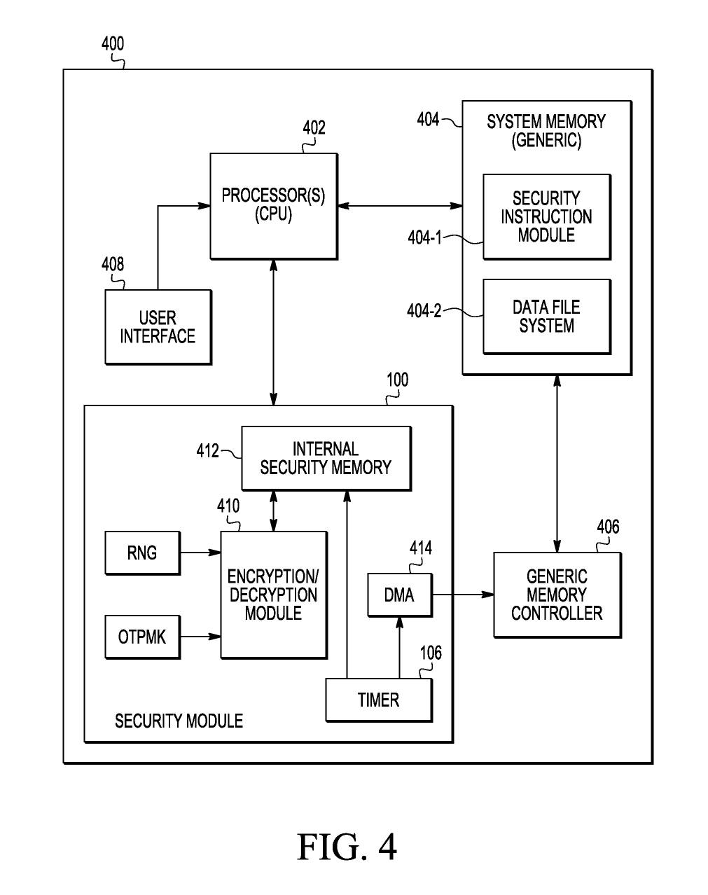

FIG. 4 is a block diagram of an example computing device 400 comprising the security module 100 of FIG. 1, according to an embodiment of the invention. In addition to the security module 100, the computing device 400 comprises one or more other processors 402 (having at least a central processing unit (CPU)), generic system memory 404, a generic memory controller 406, and a user interface 408. The computing device 400 is suitable for practicing the exemplary embodiments of the present invention, e.g., in reference to FIGS. 1-3, and a specific manner in which components are configured to enable the computing device 400 to operate. The computing device 400 may be implemented as part of any suitable electronic system, such as a mobile phone, a wireless communication device, an electronic game device, an electronic reader device, a DVD player, a portable wireless device, a radio device, etc.

The system memory 404 comprises a module 404-1 for providing instructions to the security module 100 to implement various steps described herein in reference to FIGS. 1-3. The system memory 404 also includes a data file system 404-2 for storing the encrypted key blob 130 of FIG. 1 as well as the decrypted data 202 of FIG. 2.

As shown in FIG. 4, in addition to the elements also shown in FIGS. 1-3, the security module 100 comprises an encryption/decryption engine 410, internal security memory 412, and a direct memory access (DMA) controller 414. As described in the context of FIG. 1, the encryption/decryption engine 410 encrypts the data 120 and the blob key BK. As described in the context of FIGS. 2 and 3, the encryption/decryption engine 410 decrypts the encrypted blob key 104 and the encrypted data 102. The internal security memory 412 stores the decrypted data 202 and the decrypted blob key BK of FIG. 3. The DMA controller 414 provides the security module 100 with access to the generic system memory 404 via the generic memory controller 406.

Various embodiments of the system memory 404 and the internal security memory 412 can be semiconductor-based memory devices, magnetic memory devices and systems, optical memory devices and systems, fixed memory, removable memory, disc memory, flash memory, DRAM, SRAM, EEPROM, and the like. Various embodiments of the one or more other processors 402 may include but are not limited to general purpose computers, special purpose computers, microprocessors, digital signal processors (DSPs), and multi-core processors.

All components of the security module 100 can be implemented using hardware components known to a person skilled in the art. But generally, the security module 100 may be implemented as a combination of hardware, software, and/or firmware.

Although the random number generator RNG, the register OTPMK, and the timer 106 are shown as being implemented as part of the security module 100 in FIGS. 2-4, in alternative embodiments, one or more of those elements may be implemented outside of the security module 100. It is further noted that all or selected modules of the computing device 400 in FIG. 4 may implemented as a single integrated circuit.

Although the encryption processing of FIG. 1 and the decryption processing of FIGS. 2 and 3 have been described in the context of specific sequences of processing steps, the order of some of those steps may be changed in different implementations. For example, in FIG. 1, the retrieval of the blob-key encryption key BKEK of Step 4 may be implemented before or in parallel with the encryption of the blob key BK of Step 3. As another example, the starting of the timer 106 of Step 2a/2b of FIGS. 2 and 3 may be implemented at any suitable time after Step 1a/1b.

Although the invention has been described in the context of data being encrypted using a randomly generated blob key BK that is itself encrypted using a fixed blob-key encryption key BKEK, the invention can also be implemented in the context of other suitable encryption schemes, involving one or more encryption keys randomly generated or not and/or encrypted or not.

Embodiments of the invention can be manifest in the form of methods and apparatuses for practicing those methods. Embodiments of the invention can also be manifest in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. Embodiments of the invention can also be manifest in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits

Any suitable processor-usable/readable or computer-usable/readable storage medium may be utilized. The storage medium may be (without limitation) an electronic, magnetic, optical, electromagnetic, infrared, or semiconductor system, apparatus, or device. A more-specific, non-exhaustive list of possible storage media include a magnetic tape, a portable computer diskette, a hard disk, a random access memory (RAM), a read-only memory (ROM), an erasable programmable read-only memory (EPROM) or Flash memory, a portable compact disc read-only memory (CD-ROM), an optical storage device, and a magnetic storage device. Note that the storage medium could even be paper or another suitable medium upon which the program is printed, since the program can be electronically captured via, for instance, optical scanning of the printing, then compiled, interpreted, or otherwise processed in a suitable manner including but not limited to optical character recognition, if necessary, and then stored in a processor or computer memory. In the context of this disclosure, a suitable storage medium may be any medium that can contain or store a program for use by or in connection with an instruction execution system, apparatus, or device.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

In describing alternate embodiments of the apparatus claimed, specific terminology is employed for the sake of clarity. The invention, however, is not intended to be limited to the specific terminology so selected. Thus, it is to be understood that each specific element includes all technical equivalents that operate in a similar manner to accomplish similar functions.

It is to be understood that the foregoing description is intended to illustrate and not to limit the scope of the invention, which is defined by the scope of the appended claims. Other embodiments are within the scope of the following claims.

It is noted that various non-limiting embodiments described and claimed herein may be used separately, combined, or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An article of manufacture comprising a computing device comprising a security module configured to:
receive a request to decrypt encrypted data;
set up an uninterruptible timer based on a specified time interval;
decrypt the encrypted data to generate and store corresponding decrypted data in a memory within the computing device; and
provide a trigger signal to delete the decrypted data from the memory after expiration of the specified time interval as determined by the uninterruptible timer.

2. The article of claim 1, wherein:
the encrypted data is part of a key blob further comprising an encrypted blob key; and
the security module is configured to:
decrypt the encrypted blob key using a blob-key encryption key to generate a decrypted version of a blob key; and
decrypt the encrypted data using the decrypted version of the blob key to generate the decrypted data.

3. The article of claim 2, wherein the security module is further configured to:
encrypt data using the blob key to generate the encrypted data;
encrypt the blob key using the blob-key encryption key to generate the encrypted blob key; and
combine the encrypted data and the encrypted blob key to generate the key blob.

4. The article of claim 3, wherein the computing device comprises:
a random number generator configured to generate the blob key; and
a register configured to store the blob-key encryption key.

5. The article of claim 4, wherein the security module comprises the random number generator and the register.

6. The article of claim 1, wherein the security module comprises the timer.

7. The article of claim 1, wherein the memory is a generic system memory outside of the security module.

8. The article of claim 1, wherein the memory is a secure memory inside the security module.

9. The article of claim 1, wherein the computing device is implemented as an integrated circuit comprising the security module.

10. A method for an article of manufacture comprising a computing device comprising a security module, the method comprising:
the security module receiving a request to decrypt encrypted data;
the security module setting up an uninterruptible timer based on a specified time interval;
the security module decrypting the encrypted data to generate and store corresponding decrypted data in a memory within the computing device; and
the security module providing a trigger signal to delete the decrypted data from the memory after expiration of the specified time interval as determined by the timer.

11. A non-transitory machine-readable storage medium, having encoded thereon program code, wherein, when the program code is executed by a machine, the machine implements a method for an article of manufacture comprising a computing device comprising a security module, the method comprising:
the security module receiving a request to decrypt encrypted data;
the security module setting up an uninterruptible timer based on a specified time interval;
the security module decrypting the encrypted data to generate and store corresponding decrypted data into memory within the computing device; and
the security module providing a trigger signal to delete the decrypted data from the memory after expiration of the timer's specified time interval.
